(19) United States
(12) Patent Application Publication
(10) Pub. No.: US 2018/0337886 A1
(43) Pub. Date: Nov. 22, 2018

(54) UPGRADING TO DIRECT CONNECTION FOR SERVERS BEHIND A NETWORK ADDRESS TRANSLATION DEVICE

(71) Applicant: FILEGEAR INC., San Francisco, CA (US)

(72) Inventor: Douglas Allen Walter, Shanghai (CN)

(73) Assignee: FILEGEAR INC., San Francisco, CA (US)

(21) Appl. No.: 15/974,174

(22) Filed: May 8, 2018

Related U.S. Application Data
(60) Provisional application No. 62/508,098, filed on May 18, 2017.

(51) Int. Cl. H04L 29/12; H04L 29/06

(52) U.S. Cl. CPC H04L 61/2575; H04L 61/2589; H04L 61/2517; H04L 67/42; H04L 69/24; H04L 61/2567

(57) ABSTRACT

Techniques of gracefully switching to direct connections for devices behind NAT devices are described. A server device behind a first NAT device receives a request to establish one or more peer-to-peer connections with a client device behind a second NAT device. The server device can establish a first peer-to-peer connection with the client device through a relay device that is publicly reachable by both the server device and the client device. The server device negotiates a second peer-to-peer connection with the client device, while the client device downloads content from the server device over the first peer-to-peer connection. The second peer-to-peer connection is on a network route that is different from a route of the first peer-to-peer connection. Once the second peer-to-peer connection is established, the server device and the client device can communicate with one another using the second peer-to-peer connection.

### CROSS-REFERENCE TO RELATED APPLICATIONS

This application is a non-provisional of and claims priority to U.S. Provisional Patent Application No. 62/508,098, filed on May 18, 2017, the entire contents of which are hereby incorporated by reference.

### TECHNICAL FIELD

This disclosure relates generally to computer networking.

### BACKGROUND

In today's world of Internet of Things (IOT), billions of devices and microservices are connected to the Internet. Many of these Internet devices are connected behind a network address translation (NAT) device. A NAT device can map Internet Protocol (IP) address from one address space to another. Accordingly, for example, a NAT device can map multiple internal IP addresses to a single external, public facing IP address. NAT devices help to solve the problem of limited number of public facing IP addresses that are used to identify and route traffic on the Internet. By placing devices behind a NAT, multiple devices and services can share one IP address.

### SUMMARY

Techniques of gracefully switching to direct connections for devices behind NAT devices are described. A server device behind a first NAT device receives a request to establish one or more peer-to-peer connections with a client device behind a second NAT device. The server device can establish a first peer-to-peer connection with the client device through a relay device that is publicly reachable by both the server device and the client device. The server device negotiates a second peer-to-peer connection with the client device, while the client device downloads content from the server device over the first peer-to-peer connection. The second peer-to-peer connection is on a network route that is different from a route of the first peer-to-peer connection. The second peer-to-peer connection can be a connection that is more efficient than the first peer-to-peer connection but takes longer to establish. Once the second peer-to-peer connection is established, the server device and the client device can communicate with one another using the second peer-to-peer connection.

Techniques of multiplexing peer-to-peer connections are described. A server device behind a first NAT device receives a request to establish one or more peer-to-peer connections with a client device behind a second NAT device. The server device establishes a first peer-to-peer connection with the client device through a relay device. The server device provides, through the first peer-to-peer connection, a control message to the client device for establishing a multiplexed connection under a multiplexed connection protocol, e.g., a Quick UDP Internet Connections (QUIC) protocol. The multiplex connection can have multiple apparently independent communication channels. The server device and the client device establishes the multiplexed connection over the first peer-to-peer connection or a second, direct peer-to-peer connection. Once the multiplexed connection is established, the server device and the client device can communicate with one another using the multiplexed connection.

The features described in this specification can be implemented to achieve one or more advantages. Compared to conventional peer-to-peer connection technology, the disclosed techniques appear more responsive to user request. When a user using a client device requesting a peer-to-peer connection to a server device, a first peer-to-peer connection through a relay device is quickly established. The peer-to-peer connection, going through the relay device, may not be a fastest possible connection. While the user downloads content over the first peer-to-peer connection, the client device and the server device negotiate a more efficient and faster connection, e.g., a direct connection. The protocol for establishing the direct connection may have a high initial overhead. For example, a Session Traversal Utilities for NAT (STUN) discovery protocol may utilize a series of message exchanges and fixed timeout values. The exchanges and timeout may cause the discovery process, especially in failure cases, to take a long time to complete. Since the user is already downloading content over the first peer-to-peer relayed connection, the exchange and timeout for establishing the second peer-to-peer direct connection are masked and imperceptible to the user. Once the direct connection is established, the server device and the client device switch to the direction connection, where download speed increases. This can give a positive user experience for users who are accustomed to getting near-instant results on the Web.

Compared to conventional implementations, the disclosed techniques are more efficient. The disclosed techniques avoid multiple single point-to-point connections when a Web application on a client device requests multiple separate connections, for example, to download images, movies and other Web content in parallel. While conventional peer-to-peer connection technologies will create each of the connections from the scratch, the disclosed techniques enable a client device to simultaneously request multiple Web resources from the server device, thus further reducing delays and processing overhead.

The disclosed techniques have various applications. For example, the disclosed techniques are suitable for a file download application where one or more mass storage devices storing files are located behind a NAT, e.g., a router, in a home or office. A user can access the files remotely using a client device, e.g., a smartphone. When the user first accesses the storage devices, a first peer-to-peer connection is established quickly. The first peer-to-peer connection need not be the fastest because in the beginning, when the user may be browsing directory lists, image thumbnails or file lists. While the user browses the content, a second, faster, and multiplexed peer-to-peer connection is created, allowing the user to download files, movies, and music simultaneously using faster connection.

The details of one or more implementations of the subject matter described in this specification are set forth in the accompanying drawings and the description below. Other features, aspects and advantages of the subject matter will become apparent from the description below, the drawings and the claims.

### BRIEF DESCRIPTION OF THE DRAWINGS

FIG. 1 is a block diagram illustrating example techniques of gracefully switching to direct connections for devices behind NAT devices.

FIG. 2 is a block diagram illustrating example techniques of multiplexing peer-to-peer connections.

FIG. 3 is a flowchart illustrating an example of a procedure of gracefully switching to direct connections for devices behind NAT devices.

FIG. 4 is a flowchart illustrating an example of a server-side procedure of multiplexing peer-to-peer connections.

FIG. 5 is a flowchart illustrating an example of a device-side procedure of multiplexing peer-to-peer connections.

FIG. 6 is a block diagram of example of a system architecture for implementing the features and operations of FIG. 1-5.

Like reference symbols in the various drawings indicate like elements.

### DETAILED DESCRIPTION

### Example of Upgrading Peer-to-Peer Connections

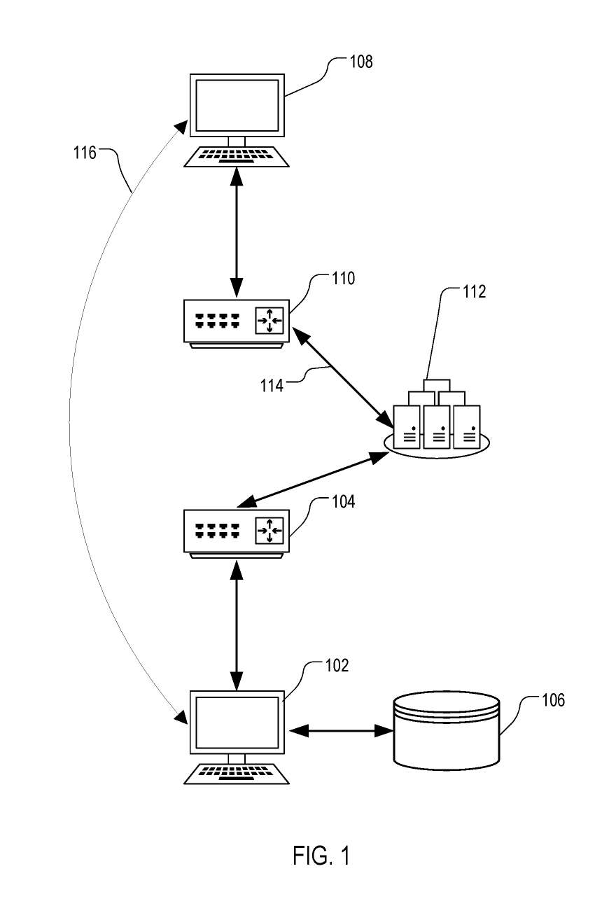

FIG. 1 is a block diagram illustrating example techniques of gracefully switching to direct connections for devices behind NAT devices. A server device 102 is logically located behind a first NAT device 104. The server device 102 can include one or more computers. The server device 102 may be coupled to one or more mass storage devices 106. The server device 102 can be configured to provide files stored on a mass storage device 106 for download. The NAT device 104 can be a router or an Internet gateway having one or more wired or wireless connection ports.

A client device 108 requests to connect to the server device 102. The client device 108 is logically located behind a second NAT device 110. The client device 108 can include one or more computers. In order to ensure the fastest possible experience between the server device 102 and the client device 108, it is desirable to create one or more peer-to-peer connections between the server device 102 and the client device 108.

The NAT device 104 may introduce a problem for the peer-to-peer connection between the server device 102 located behind

the NAT device 104 and the client device 108 that is located in the world outside of the NAT device 104. The NAT device 104 may provide a “firewall” or network protection function. Accordingly, the NAT device 104 may block all incoming traffic, unless the traffic is in response to a message originally sent from behind the NAT device 104. This makes it difficult or impossible for the client device 108, which is connected to a separate network, to trivially establish peer-to-peer connections, when the networks are separated by the NAT devices 104 and 110. For example, if the server device 102 hosts a service, e.g., a Web server to serve up Web pages, the NAT device 104 may block all unsolicited requests from the outside, therefore making the Web service inside the NAT device 104 unreachable to the client device 108.

A relay device 112 hosted in a publicly addressable place can facilitate a peer-to-peer connection. The relay device 112 can include one or more computers implementing various protocols for facilitating the peer-to-peer connection. For example, the relay device 112 can implement a protocol known as Traversal Using Relays around NAT (TURN) protocol. The relay device 112 works by receiving and forwarding packets of information between the server device 102 and the client device 108, where each of the server device 102 and the client device 108 simultaneously initiates a connection with the relay device 112. The server device 102 and the client device 108 can be connected through the relay device 112 based on the TURN protocol, through a first peer-to-peer connection 114. The relay device 112 operates by keeping a persistent connection between the server device 102 and the relay device 112 always available. The client device 108, when attempting to connect to the server device 102, connects to the relay device 112 instead. The client device 108 indicates to the relay device 112, in a server name indication (SNI) header of a transport layer security (TLS) protocol message, that the client device 108 wishes to connect to the server device 102. The relay device 112, already connected to the server device 102, can act as an intermediary by forwarding packets between the server device 102 and the client device 108. The client device 108 can then start to access the Web pages hosted by the server device 102.

Establishing the first peer-to-peer connection 114 based on the TURN protocol can be a quick process, without incurring much latency by a discovery process. A user of the client device 108 can start using the services provided by the server device 102 as soon as the first peer-to-peer connection 114 is established. For example, the client device 108 can download content through the first peer-to-peer connection 114. The content can include, for example, metadata including directory lists, thumbnails and file lists, as well as data, e.g., files, that are stored the mass storage device 106. Due to the quick establishment of the first peer-to-peer connection 114, the content can appear to be accessible almost immediately after a request is sent.

Due to packet forwarding, the communication speed over the first peer-to-peer connection 114 may be slower than the speed of a direct connection. While the server device 102 and the client device 108 are connected through the first peer-to-peer connection 114 including the relay device 112, at least one of the server device 102 or the client device 108 can attempt to create a direct peer-to-peer connection. In various implementations, the server device 102 or the client device 108 can implement various protocols that are used to facilitate the creation and discovery of holes in the NAT devices 104 and 110, a process sometimes referred to as hole punching or NAT tunneling.

For example, once the first peer-to-peer connection 114 is established between the server device 102 and the client device 108, the server device 102 can begin a negotiation process with the client device 108 by sending a control message to the client device 108 over the first peer-to-peer connection 114 to begin upgrading the first peer-to-peer connection 114 to a more desirable and more efficient connection. The server device 102 will inform the client device 108 about alternate and more efficient paths for communicating directly to the server device 102.

The server device 102 can determine whether the client device 108 is on a same internal network as the server device 102. In response to determining that the client device 108 is on a same internal network as the server device 102, the server device 102 can include a direct internal IP address of the server device 102 in the control message to the client device 108.

The server device 102 can determine whether the NAT device 104 is configured to perform port forwarding. In response to determining that the NAT device 104 is configured to perform port forwarding, the server device 102 can include a public IP address and port number of the NAT device 104 in the control message to the client device 108.

The client device 108 initiates a connection with the relay device 112. The relay device 112, in turn, has a persistent connection available with the server device 102. Since all parties are already connected through the relay device 112, the relay device 112 may store such parameters as would be necessary to exchange between server and client devices to implement the STUN protocol. These parameters can include, for example: a) the public IP and port number of the client device NAT; b) the private IP and port number of the client device 108; c) the public IP and port number of the server device 102; d) the private IP and port number of the server device 102; e) any alternative private or public IP address known by the server device 102 that might facilitate a direct connection to the server device 102 without STUN hole punching strategy; and f) any additional hints or details that might assist with the hole-punching strategy such as detected NAT type, or other network or device detail.

Once the client device 108 receives, through the relay device 112 over the first peer-to-peer connection 114, the control message to participate in the upgrade process, the server device 102 and the client device 108 will simultaneously follow the relevant procedures to upgrade the first peer-to-peer connection 114 to a more efficient connection, e.g., a connection using internal IP address or port forwarding.

In some implementations, the server device 102 and the client device 108 can cause the relay device 112 to perform hole punching. The relay device 112 can implement one or more Web-based Real-time Communications (WebRTC) protocols. The relay device 112 can implement protocols in the WebRTC to discover a direct peer-to-peer connection between the server device 102 and the client device 108 by punching holes through NAT devices 104 and 110. For example, the relay device 112 can act as a STUN server by implementing a STUN protocol. Under the STUN protocol, the relay device 112 can identify the kind of NAT devices 104 and 110 that stand between the server device 102 and the client device 108. The relay device 112 can then attempt to create and discover a direct route between the server device 102 and the client device 108 by simultaneously sending, and listening for, messages sent to and through the NAT devices 104 and 110 by the server device 102 and the client device 108, respectively. The relay device 112 being a publicly accessible intermediary, information about available routes can be exchanged between server device 102 and the client device 108, thus ultimately establishing a direct peer-to-peer connection 116 between server device 102 and the client device 108.

The direct peer-to-peer connection 116 is a connection that has a network path that is different from a network path of the first peer-to-peer connection 114. Once the direct peer-to-peer connection 116 is established, the server device 102 and the client device 108 can communicate through the direct peer-to-peer connection 116. For example, the server device 102 can cause the client device 108 to switch to the direct peer-to-peer connection 116 and start download content stored on the mass storage device 106 until such a time as the direct peer-to-peer connection 116 is no longer available. Once the direct peer-to-peer connection 116 is no longer available, the server device 102 and the client device 108 can fall back to the first peer-to-peer connection 114 and repeat the STUN discovery process. Accordingly, the user may not perceive a down time.

The STUN discovery protocol utilizes a series of message exchanges, and fixed timeout values. Accordingly, the discovery process, especially in failure cases, can take a long time to complete. However, the discovery process is performed while the server device 102 and the client device 108 are already in communication through the first peer-to-peer connection 114. Accordingly, the latency of the discovery process is masked by the communication, and a user of the client device 108 may not perceive the latency. Due to the elimination of packet forwarding, compared to the first peer-to-peer connection 114, the direct peer-to-peer connection can be faster, and unrestricted by bandwidth limits of the relay device 112. Accordingly, a user of the client device 108, when downloading content, can have an experience of both establishing a connection quickly and using a connection having fast speed.

### Example of Multiplexing Peer-to-Peer Connections

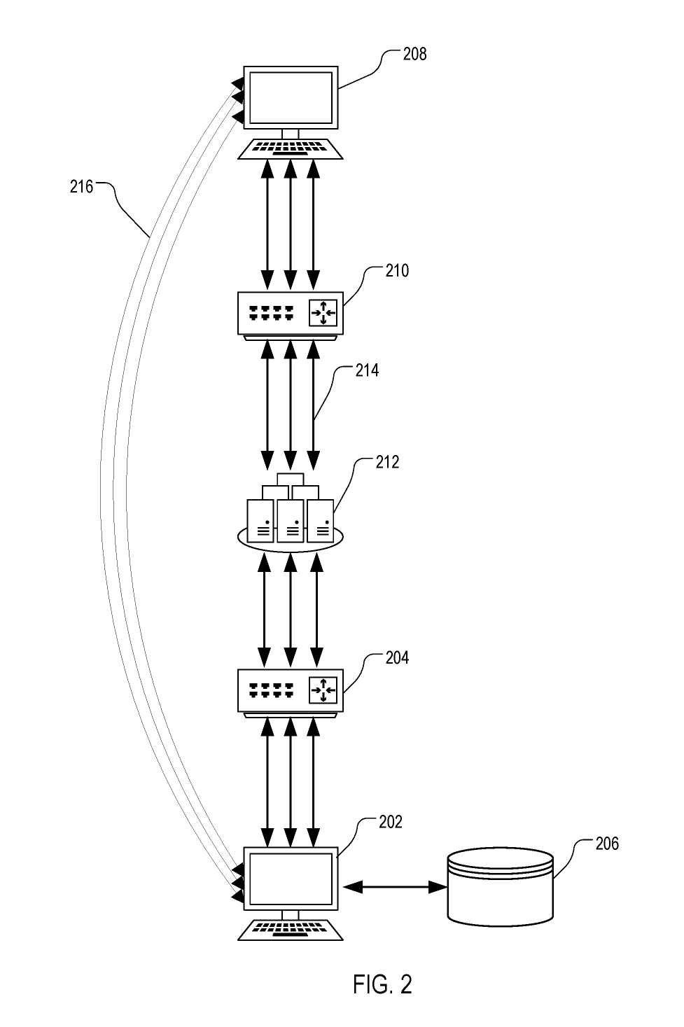

FIG. 2 is a block diagram illustrating example techniques of multiplexing peer-to-peer connections. A server device 202 is logically located behind a first NAT device 204. The server device 202 may be coupled to one or more mass storage devices 206. The server device 202 can be configured to provide files stored on a mass storage device 206 for download. The first NAT device 204 can be a router or an Internet gateway having one or more wired or wireless connection ports. A client device 208 requests to connect to the server device 202. The client device 108 is logically located behind a second NAT device 210. A relay device 212 assists the server device 202 and the client device 208 to create one or more peer-to-peer connections under STUN protocol, TURN protocol, or both.

The STUN and TURN protocols focus on single point-to-point connections. An application executing on the client device 108 may create many separate connections, for example, ten separate connections, to download images, resources, and other Web content in parallel. The images, resources and Web content may be stored in the mass storage device 206 and served by the server device 202. Because each STUN or TURN connection involves re-negotiating the connection parameters from scratch, there can be delays involved in hosting a Web server application on the server device to serve the client device 208. If each peer-to-peer connection is set up using the above-mentioned protocols using the techniques described in reference to FIG. 1, many discovery processes may need to run on the server device 202, the client device 208, or both.

To avoid the overhead of creating multiple STUN or TURN connections, each of the server device 202 and the client device 208 is configured to reuse a single connection to communicate with the client device 208 and the server device 202, rather than to create and discover multiple instances of peer-to-peer connections between the server device 202 and the client device 208. For example, the server device 202 can apply a Quick UDP Internet Connection (QUIC) protocol to create multiplexed independent connections over one negotiated peer-to-peer connection thus enabling the client device 208 to simultaneously request multiple Web resources from the server device 202 and further reducing delays and processing overhead.

The multiplexed connections can be relayed multiplexed connections 214 implemented over one or more peer-to-peer connections that are relayed by the relay device 212. The multiplexed connections can be direct multiplexed connections 216 implemented over one or more direct peer-to-peer connections. The server device 202 and client device 208 can create the relayed or directed peer-to-peer connections using techniques described above in reference to FIG. 1.

### Example Procedures

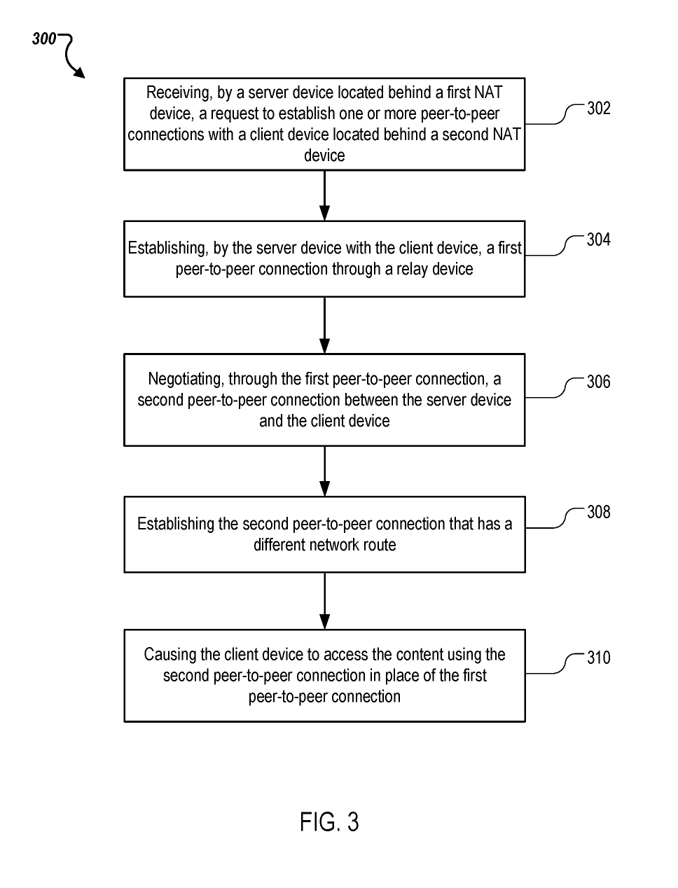

FIG. 3 is a flowchart illustrating an example of a procedure 300 of gracefully switching to direct connections for devices behind NAT devices. The procedure 300 can be implemented by a server device including one or more computers, e.g., the server device 102 of FIG. 1 or the server device 202 of FIG. 2.

The server device receives (302) a request to establish one or more peer-to-peer connections for providing content from the server device to a client device. The server device is logically located behind a first NAT device. The client device is logically located behind a second NAT device. The second NAT device and the client device can be logically located outside of a local network inside of the first NAT device, e.g., the second NAT device and the client device are not part of a subnet behind the first NAT device.

The server device establishes (304), with the client device, a first peer-to-peer connection through a first network route that includes a relay device that is logically located between the first NAT device and the second NAT device. The relay device is publicly reachable by both the server device and client device. The first peer-to-peer connection is established based on packet forwarding, where the relay server forwards packets from the server device to the client device and forwards packets from the client device to the server device. The first peer-to-peer connection can be established using the protocol for hole punching, e.g., a NAT traversal protocol such as the TURN protocol. The client device can start downloading content immediately after the first peer-to-peer connection is established.

The server device negotiates (306) with the client device a second peer-to-peer connection between the server device and the client device. The negotiation occurs through the first peer-to-peer connection. The second peer-to-peer connection can be discovered and created using a STUN protocol. Negotiating the second peer-to-peer connection can include submitting, by the server device to the client device through the first peer-to-peer connection, a control message. The control message can request the client device to create a second peer-to-peer connection between the server device and the client device. Negotiating the second peer-to-peer connection can occur while at least a portion of the content passes through the first peer-to-peer connection. The control message can indicate the second network route for the second peer-to-peer connection. The second network route, e.g., a direct route, can be more efficient than the first network route of the first peer-to-peer connection.

The control message can include a direct internal IP address of the server device when the server device determines that (1) the second NAT device and the client device are logically located inside of a local network behind first NAT device, or (2) the first NAT device is the second NAT device. The control message can include a public IP address of the first NAT device and a port of the first NAT device when the first NAT device is configured to perform port forwarding. The control message can include one or more parameters for executing STUN based NAT hole punching procedures to create and discover a direct peer-to-peer connection.

The server device establishes (308) the second peer-to-peer connection between the client device and the server device. The server device can establish the second peer-to-peer connection using a relay device, e.g., a STUN server. The second peer-to-peer connection has a second network route that is different from the first network route. For example, the second peer-to-peer connection does not go through the relay device.

The server device causes (310) the client device to access the content using the second peer-to-peer connection in place of the first peer-to-peer connection. Causing the client device to use the second peer-to-peer connection can occur in response to determining that the second peer to peer connection is established and is more efficient. After establishing the second peer-to-peer connection, the server device may determine that the second peer-to-peer connection fails. In response to determining that the second peer-to-peer connection fails, the server device can re-negotiate the second peer-to-peer connection while the content passes through the first peer-to-peer connection. The failure is thus masked by the content flow.

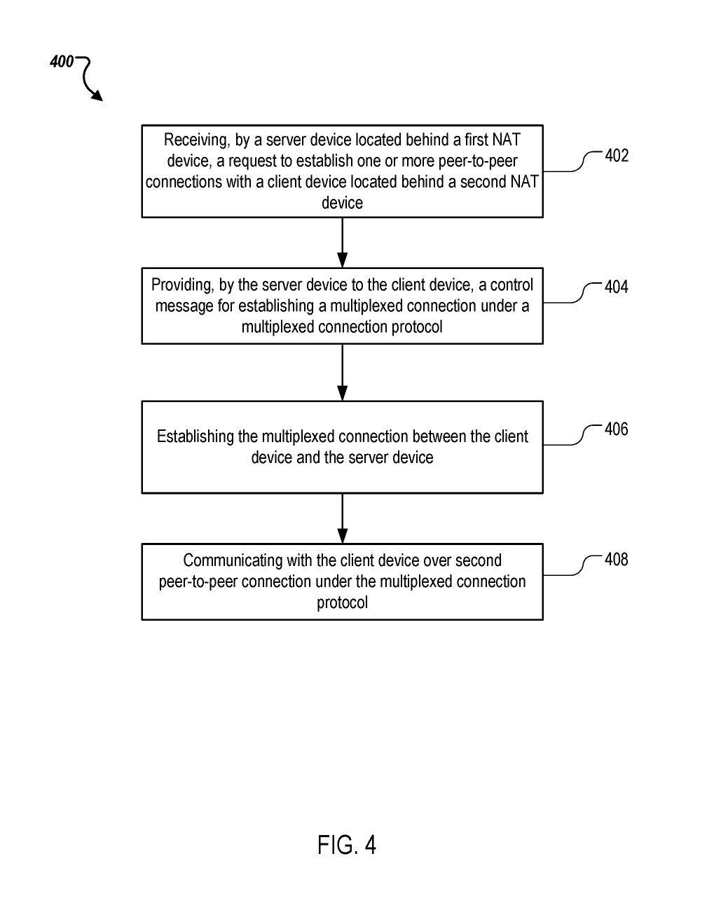

FIG. 4 is a flowchart illustrating an example of a server-side procedure 400 of multiplexing peer-to-peer connections. The procedure 400 can be performed by a server device, e.g., the server device 102 of FIG. 1 or the server device 202 of FIG. 2.

The server device receives (402) a request to establish one or more peer-to-peer connections for providing content from the server device to a client device. The server device is logically located behind a first NAT device. The client device is logically located behind a second NAT device. The second NAT device and the client device can be logically located outside of a local network inside of the first NAT device, e.g., the second NAT device and the client device are not part of a subnet behind the first NAT device.

The server device provides (404) to the client device a control message for establishing a multiplexed connection under a multiplexed connection protocol. The server device sends the control message to the client device over a first peer-to-peer connection. The first peer-to-peer connection is established through a first network route including a relay device that is logically located between the first NAT device and the second NAT device. The first peer-to-peer connection can be established based on a NAT traversal protocol, e.g., the TURN protocol, in response to the request. The multiplexed connection protocol can be a Quick UDP Internet Connection (QUIC) protocol.

The server device establishes (406) the multiplexed connection between the client device and the server device. The multiplexed connection includes multiple apparently separate and apparently independent connections. The multiplexed connection can be established over the first network route. In some implementations, the server device can establish or cause to be established a second peer-to-peer connection between the server device and the client device. The second peer-to-peer connection can have a second network route that does not include the relay device. The second peer-to-peer connection can be a direct connection based on a STUN protocol. The server device can establish the multiplexed connection with the client device over the second peer-to-peer connection under the multiplexed connection protocol. The multiplexed connection can be established over the second peer-to-peer connection on the second network route.

The server device communicates (408) with the client device over the multiplexed connection under the multiplexed connection protocol, including providing the content for download through the multiplexed connection. The client device can provide the content, e.g., images, movies, or music on a display surface or a speaker.

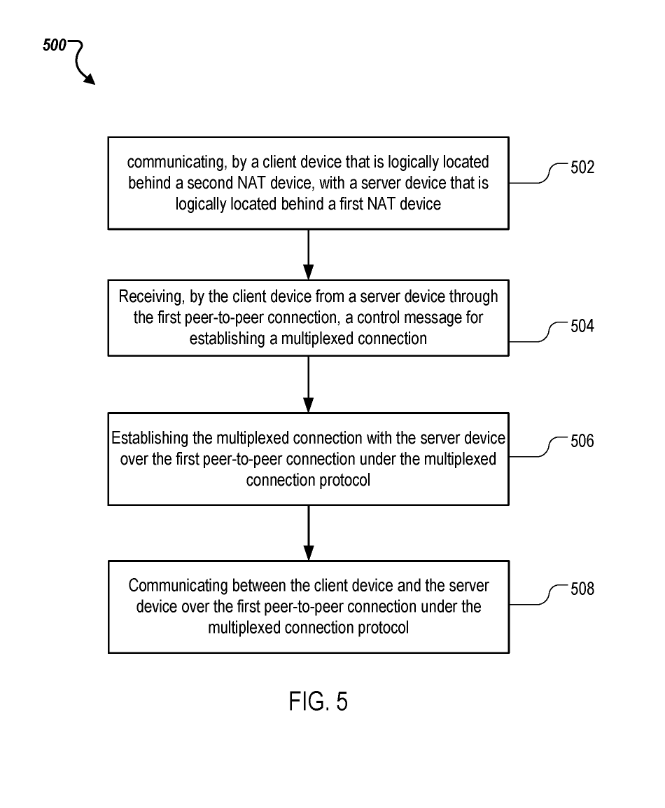

FIG. 5 is a flowchart illustrating an example of a device-side procedure 500 of multiplexing peer-to-peer connections. The procedure 500 can be performed by a client device including one or more computers, e.g., the client device 108 of FIG. 1 or the client device 208 of FIG. 2.

The client device communicates (502) with a server device over a first peer-to-peer connection through a relay device. The server device is logically located behind a first NAT device. The client device is logically located behind a second NAT device. The second NAT device and the client device can be logically located outside of a local network inside of the first NAT device, e.g., the second NAT device and the client device are not part of a subnet behind the first NAT device. The first peer-to-peer connection is a connection based on a NAT traversal protocol, e.g., the TURN protocol.

The client device receives (504) from the server device through the first peer-to-peer connection, a control message for establishing a multiplexed connection under a multiplexed connection protocol. The multiplexed connection protocol is a QUIC protocol.

The client device establishes (506) the multiplexed connection with the server device over the first peer-to-peer connection under the multiplexed connection protocol. In some implementations, the client device can create a second peer-to-peer connection between the server device and the client device communicate over the first peer-to-peer connection through the relay device. The second peer-to-peer connection is based on a STUN protocol. The second peer-to-peer connection has a network path that is different from a network path of the first peer-to-peer connection.

The client device communicates (508) with the server device over the first peer-to-peer connection under the multiplexed connection protocol. For example, the client device downloads content by the client device from the server device over the multiplexed connection. After the second peer-to-peer connection is created, the client device can upgrade the multiplexed connection by creating a second multiplexed connection over the second peer-to-peer connection and communicating with the server device through the second multiplexed connection.

### Example System Architecture

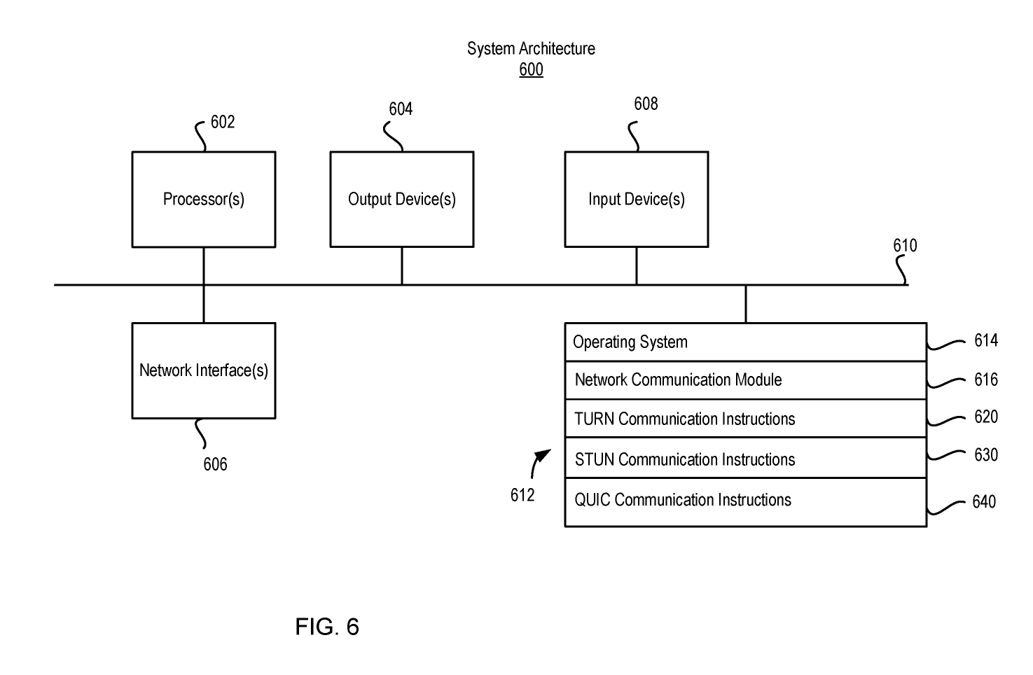

FIG. 6 is a block diagram of a system architecture 600 for implementing the features and operations of FIG. 1-5. Other architectures are possible, including architectures with more or fewer components. In some implementations, architecture 600 includes one or more processors 602 (e.g., dual-core Intel® Xeon® Processors), one or more output devices 604 (e.g., an interface to a LCD monitor), one or more network interfaces 606, one or more input devices 608 (e.g., a mouse, keyboard, touch-sensitive display, or a remote control) and one or more computer-readable mediums 612 (e.g., RAM, ROM, SDRAM, hard disk, optical disk, flash memory, etc.). These components can exchange communications and data over one or more communication channels 610 (e.g., buses), which can utilize various hardware and software for facilitating the transfer of data and control signals between components.

The term “computer-readable medium” refers to any medium that participates in providing instructions to processor 602 for execution, including without limitation, non-volatile media (e.g., optical or magnetic disks), volatile media (e.g., memory) and transmission media. Examples of transmission media include, without limitation, coaxial cables, copper wire and fiber optics.

Computer-readable medium 612 can further include operating system 614 (e.g., Mac OS® server, Windows Server®, UNIX®, Linux®, or iOS®), network communication module 616, TURN communication instructions 620, STUN communication instructions 630, and QUIC communication instructions 640. Operating system 614 can be multi-user, multiprocessing, multitasking, multithreading, real time, etc. Operating system 614 performs basic tasks, including but not limited to: recognizing input from and providing output to devices 606, 608; keeping track and managing files and directories on computer-readable mediums 612 (e.g., memory or a storage device); controlling peripheral devices; and managing traffic on the one or more communication channels 610. Network communications module 616 includes various components for establishing and maintaining network connections (e.g., software for implementing communication protocols, such as TCP/IP, HTTP, etc.). TURN communication instructions 620 can include computer instructions that, when executed, cause processor 602 to establish a first peer-to-peer connection with another device through two NAT devices and a relay device under the TURN protocol. STUN communication instructions 630 can include computer instructions that, when executed, cause processor 602 to establish a second peer-to-peer connection, under the STUN protocol, with the device that is different from the first peer-to-peer connection. QUIC communication instructions 640 can include computer instructions that, when executed, cause processor 602 to create a multiplexed connection under the QUIC protocol over the first peer-to-peer connection or the second peer-to-peer connection.

Architecture 600 can be implemented, for example, in a parallel processing or peer-to-peer infrastructure or on a single device with one or more processors. Software can include multiple software components or can be a single body of code.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., C, SQL, or Java), including compiled or interpreted languages, and it can be deployed in any form, including as a stand-alone program or as a module, component, subroutine, a browser-based web application, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, a PAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

Although particular implementations are described above, various modifications can be made. Accordingly, other implementations are within the scope of the claims.

What is claimed is:

1. A method comprising:
receiving, by a server device logically located behind a first network address translation (NAT) device, a request to establish one or more peer-to-peer connections for providing content from the server device to a client device logically located behind a second NAT device;
establishing, by the server device with the client device, a first peer-to-peer connection through a first network route that includes a relay device that is logically located between the first NAT device and the second NAT device, the relay device being reachable by the server device and client device;
negotiating, by the server device with the client device through the first peer-to-peer connection, a second peer-to-peer connection between the server device and the client device;
establishing, by the server device, the second peer-to-peer connection between the client device and the server device, the second peer-to-peer connection having a second network route that is different from the first network route; and
causing the client device to access the content using the second peer-to-peer connection in place of the first peer-to-peer connection.

2. The method of claim 1 wherein the second NAT device and the client device are logically located outside of a local network inside of the first NAT device.

3. The method of claim 1, wherein the first peer-to-peer connection is established based on packet forwarding, where the relay server forwards packets from the server device to the client device and forwards packets from the client device to the server device.

4. The method of claim 1, wherein:
the relay device maintains a persistent connection with the server device,
the first peer-to-peer connection is a connection based on a NAT traversal protocol, and
the second peer-to-peer connection is discovered and created using a Session Traversal Utilities for NAT (STUN) protocol.

5. The method of claim 1, where negotiating includes submitting, by the server device to the client device through the first peer-to-peer connection, a control message, the control message requesting the client device to create a second peer-to-peer connection between the server device and the client device.

6. The method of claim 5, wherein the control message indicates the second network route for the second peer-to-peer connection, the second network route being more efficient than the first network route of the first peer-to-peer connection.

7. The method of claim 5, wherein the control message includes a direct internal IP address of the server device when the server device determines that:
the second NAT device and the client device are logically located inside of a local network behind the first NAT device, or
the first NAT device is the second NAT device.

8. The method of claim 5, wherein the control message includes a public IP address of the first NAT device and a port of the first NAT device when the first NAT device is configured to perform port forwarding.

9. The method of claim 5, wherein the control message includes one or more parameters for executing STUN based NAT hole punching procedures to create and discover a direct peer-to-peer connection.

10. The method of claim 1, wherein causing the client device to use the second peer-to-peer connection occurs in response to determining that the second peer to peer connection is more efficient.

11. The method of claim 1, comprising, in response to determining that the second peer-to-peer connection fails, re-negotiating the second peer-to-peer connection while the content passes through the first peer-to-peer connection.

12. One or more non-transitory computer-readable storage media storing computer instructions that, when executed, cause one or more computing devices to perform operations comprising:
receiving, by a server device logically located behind a first network address translation (NAT) device, a request to establish one or more peer-to-peer connections for providing content from the server device to a client device logically located behind a second NAT device;
establishing, by the server device with the client device, a first peer-to-peer connection through a first network route that includes a relay device that is logically located between the first NAT device and the second NAT device, the relay device being reachable by the server device and client device;
negotiating, by the server device with the client device through the first peer-to-peer connection, a second peer-to-peer connection between the server device and the client device;
establishing, by the server device, the second peer-to-peer connection between the client device and the server device, the second peer-to-peer connection having a second network route that is different from the first network route; and
causing the client device to access the content using the second peer-to-peer connection in place of the first peer-to-peer connection.

13. The one or more non-transitory computer-readable storage media of claim 12, wherein negotiating the second peer-to-peer connection between the server device and the client device includes: submitting, by the server device to the client device through the first peer-to-peer connection, a control message, the control message requesting the client device to create a second peer-to-peer connection between the server device and the client device.

14. The one or more non-transitory computer-readable storage media of claim 13, wherein the control message indicates the second network route for the second peer-to-peer connection, the second network route being more efficient than the first network route of the first peer-to-peer connection.

15. The one or more non-transitory computer-readable storage media of claim 13, wherein the control message includes a direct internal IP address of the server device when the server device determines that:
the second NAT device and the client device are logically located inside of a local network behind the first NAT device, or
the first NAT device is the second NAT device.

16. The one or more non-transitory computer-readable storage media of claim 13, wherein the control message includes a public IP address of the first NAT device and a port of the first NAT device when the first NAT device is configured to perform port forwarding.

17. The one or more non-transitory computer-readable storage media of claim 13, wherein the control message includes one or more parameters for executing STUN based NAT hole punching procedures to create and discover a direct peer-to-peer connection.

18. A system comprising:
one or more computing devices; and
one or more non-transitory computer-readable storage medium storing computer instructions operable to cause the one or more computing devices to perform operations comprising:
receiving, by a server device logically located behind a first network address translation (NAT) device, a request to establish one or more peer-to-peer connections for providing content from the server device to a client device logically located behind a second NAT device;
establishing, by the server device with the client device, a first peer-to-peer connection through a first network route that includes a relay device that is logically located between the first NAT device and the second NAT device, the relay device being reachable by the server device and client device;
negotiating, by the server device with the client device through the first peer-to-peer connection, a second peer-to-peer connection between the server device and the client device;
establishing, by the server device, the second peer-to-peer connection between the client device and the server device, the second peer-to-peer connection having a second network route that is different from the first network route; and
causing the client device to access the content using the second peer-to-peer connection in place of the first peer-to-peer connection.

19. The system of claim 18, wherein the second NAT device and the client device are logically located outside of a local network inside of the first NAT device.

20. The system of claim 18, wherein the first peer-to-peer connection is established based on packet forwarding, where the relay server forwards packets from the server device to the client device and forwards packets from the client device to the server device.
